(19) United States
(12) Patent Application Publication
(10) Pub. No.: US 2010/0016205 A1
(43) Pub. Date: Jan. 21, 2010

(54) USE OF IONIC LIQUIDS AS AN ADDITIVE FOR CLEANING PROCESSES IN LIQUEFIED AND/OR SUPERCRITICAL GAS

(75) Inventor: Peter SCHWAB, Essen (DE)

Correspondence Address: FROMMER LAWRENCE & HAUG, 745 FIFTH AVENUE- 10TH FL., NEW YORK, NY, 10151, US

(73) Assignee: Evonik Goldschmidt GmbH, Essen (DE)

(21) Appl. No.: 12/503,938

(22) Filed: Jul. 16, 2009

(30) Foreign Application Priority Data
Jul. 17, 2008 (DE) 102008040486.1

(51) Int. Cl. C11D 17/08

(52) U.S. Cl. 510/244; 510/109; 510/245; 510/275; 510/338; 510/407

(57) ABSTRACT

The invention relates to the use of at least one ionic liquid or of a mixture of ionic liquids as a detergent for the cleaning of articles with a compressed gas.

This application claims benefit under 35 U.S.C. 119(a) of German patent application 10 2008 040486.1, filed on 17 Jul. 2008.

Any foregoing applications, including German patent application DE 10 2008 040486.1, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to the use of ionic liquids as an additive for cleaning processes in liquefied and/or supercritical gas according to the preamble of claim 1, especially in liquid and/or supercritical carbon dioxide.

Cleaning processes in liquid and/or supercritical gases can be used to free different articles of extraneous substances. The gases used are, for example, carbon dioxide, helium, argon, xenon, krypton, nitrogen oxides such as dinitrogen monoxide, hydrocarbons such as methane, ethane, propane, butane, pentane, ethylene, propylene, halogenated hydrocarbons and halogen-sulphur compounds such as sulphur hexafluoride. Particularly advanced processes are those for cleaning textiles, yarns, leather and comparable materials and surfaces with liquid or supercritical CO₂, as described, for example, in DE 101 11 427. The process is notable particularly for eco-friendliness and the material-conserving cleaning method. For effective cleaning, the addition of detergents is necessary. Important detergent classes, for example, perfluoroalkylpoly(ethylene oxide) copolymers, AO-VAc (sodium bis(vinyl acetate)-8-sulphosuccinate) or AOK (sodium bis(5,5-dimethyl-4-oxohexyloxocarbonyl)-sulphosuccinate) are described in U.S. Pat. No. 5,783,082 and in Eastoe et al. Langmuir 2006, 22, 9832. The purpose of the detergents is the emulsification/dispersion of impurities in the solvent, such that they are effectively transported away with the solvent stream.

These known detergents each have different disadvantages. More particularly, they all exhibit weaknesses in the removal of hydrophilic, polar stains, for example of sweat stains. This weakness also limits the process in relation to the substrates to be cleaned. Hydrophilic substances, for example cotton, can be freed of soiling only with significant restrictions.

Generally, it can be stated that it is impossible to stabilize sufficient amounts of water in the compressed gas phase. It is therefore desirable to provide substances which form inverse micelles in compressed gas phases, especially in liquid CO₂, and possess hydrophilic character.

It was therefore an object of the present invention to provide alternative detergents which are suitable, as detergents, for promoting or for improving the cleaning of articles to remove hydrophilic and/or polar impurities in compressed gas phases, especially when the compressed gas phase used is liquid or supercritical CO₂.

It has been found that, surprisingly, this object can be achieved by using one or more ionic liquids as detergents. The present invention therefore provides cleaning compositions comprising a compressed gas and at least one detergent, which are characterized in that at least one detergent is an ionic liquid.

The present invention likewise provides a process for cleaning articles, in which the articles are contacted with a cleaning composition comprising a compressed gas and at least one detergent, characterized in that an inventive cleaning composition is used.

The inventive use of at least one ionic liquid as a detergent has the advantage that it forms inverse micelles in compressed gas phases, especially in liquid or supercritical CO₂, which have polar character and absorb water or hydrophilic and/or polar impurities from surfaces and can be transported away with the solvent stream. It is thus possible for the first time to use a detergent which allows the cleaning of surfaces contaminated with hydrophilic, polar substances in compressed gases, especially liquid or supercritical CO₂.

The inventive use of at least one ionic liquid as a detergent has, more particularly, the advantage that the cleaning of hydrophilic textiles, for example cotton, in compressed gases, especially in liquid or supercritical CO₂, is also possible.

By virtue of a suitable selection of one or more ionic liquids, a tailored detergent can be provided, which satisfies the requirements with regard to the aforementioned properties.

The inventive use of ionic liquids in cleaning compositions also has the advantage of a process simplification, since complicated aqueous preliminary cleaning and subsequent drying of the articles to be cleaned can be dispensed with.

In addition, in the case of the inventive use of cleaning compositions comprising ionic liquids, they may comprise additives which nourish, protect or modify the articles to be cleaned, and can also be introduced by the cleaning process or can be applied to the articles during the cleaning process.

A further particular advantage of the inventive use of ionic liquids in cleaning compositions is that the ionic liquid used as a detergent can be removed completely from the compressed gas in a simple manner, by distilling the compressed gas and any further distillable substances out of the used cleaning composition. This is possible because ionic liquids have no measurable vapour pressure and other substances can thus be removed very easily by distillation.

The inventive cleaning compositions and the use thereof will be described by way of example hereinafter, without any intention that the invention be restricted to these illustrative embodiments. Where ranges, general formulae or compound classes are specified below, these shall encompass not just the corresponding ranges or groups of compounds which are mentioned explicitly but also all sub-ranges and sub-groups of compounds which can be obtained by selecting individual values (ranges) or compounds. When documents are cited within the present description, their content shall be incorporated fully into the disclosure content of the present invention.

The inventive cleaning composition comprising a compressed gas and at least one detergent is characterized in that at least one detergent is an ionic liquid. The inventive cleaning composition preferably consists exclusively of one or more ionic liquids and one or more compressed gases.

The ionic liquids present in the cleaning composition may be all known ionic liquids. Reviews of ionic liquids, their preparation and their properties can be found, for example, in “Ionic Liquids in Synthesis”, P. Wasserscheid, T. Welton (eds.), Wiley, in “Green Industrial Applications of Ionic Liquids”, NATO Science Series. Li. Mathematics, Physics and Chemistry, 92, or in “Ionic Liquids: Industrial Applications for Green Chemistry”, Robin D. Rogers (ed.), Acs. Symposium Series, 818.

The inventive cleaning composition may comprise, as a detergent, not just one ionic liquid, but rather it may also comprise a mixture of ionic liquids.

The compressed gas is preferably present as a liquid or supercritical phase in the inventive cleaning composition. The inventive composition preferably comprises, as the compressed gas, carbon dioxide, helium, argon, xenon, krypton, a nitrogen oxide, preferably dinitrogen monoxide, a hydrocarbon, preferably methane, ethane, propane, butane, pentane, ethylene or propylene, a halogenated hydrocarbon or a halogen-sulphur compound, preferably sulphur hexafluoride. The compressed gas in the inventive composition is more preferably carbon dioxide, especially liquid or supercritical carbon dioxide.

In the inventive composition, the mass ratio of compressed gas to ionic liquids is preferably 1 000 000:1 to 1:1, preferably 100 000:1 to 10:1, more preferably 10 000:1 to 100:1 and most preferably 5000:1 to 500:1.

The inventive cleaning composition preferably comprises, as an ionic liquid, at least one salt of the formula (I)

[A]ₙ⁺[Y]ⁿ⁻ (I)

in which

n is 1, 2, 3 or 4,

[A]⁺ is a quaternary ammonium cation, an oxonium cation, a sulphonium cation or a phosphonium cation (where these cations may in each case be substituted or unsubstituted) and

[Y]ⁿ⁻ is a monovalent, divalent, trivalent or tetra-valent anion, or a mixed salt of the general formulae (IIa) to (IIc)

[A^{1]}⁺[A^{2]}⁺ [Y]²⁻ (IIa),

[A^{1]}⁺[A^{2]}⁺[A^{3]+} [Y]³⁻ (IIb) or

[A^{1]}⁺[A^{2]}⁺[A^{3]+}[A^{4]+} [Y]⁴⁻ (IIc)

where

[A¹]+, [A²]+, [A^{3]+} and [A^{4]+} are selected independently from the groups specified for [A]⁺ and

[Y]²⁻ to [Y]⁴⁻ are each as defined for [Y]ⁿ⁻ in formula (I), or

a mixed salt of the general formulae (IIIa) to (IIIj)

[A^{1]+}[A^{2]+}[A^{3]+}[M^{1]+} [Y]⁴⁻ (IIIa),

[A^{1]+}[A^{2]+}[M^{1]+}[M^{2]+}[Y]⁴⁻ (IIIb),

[A^{1]+}[M^{1]+}[M^{2]+}[M^{3]+}[Y]⁴⁻ (IIIc),

[A^{1]+}[A^{2]+}[M^{1]+}[Y]³⁻ (IIId),

[A^{1]+}[M^{1]+}[M^{2]+}[Y]³⁻ (IIIe),

[A^{1]+}[M^{1]+}[Y]²⁻ (IIIf),

[A^{1]+}[A^{2]+}[M^{4]2+}[Y]⁴⁻ (IIIg),

[A^{1]+}[M^{1]+}[M^{4]2+}[Y]⁴⁻ (IIIh),

[A¹]+[M^{5]3+}[Y]⁴⁻ (IIII) or

[A^{1]+}[M^{4]2+}[Y]³⁻ (IIIj)

where

[A^{1]+}, [A^{2]+} and [A^{3]+} are selected independently from the groups specified for [A]⁺,

[Y]²⁻ to [Y]⁴⁻ are each as defined for [Y]ⁿ⁻ in formula I, and

[M^{1]+}, [M^{2]+}, [M^{3]+} are monovalent metal cations,

[M^{4]2+} are divalent metal cations and

[M^{5]3+} are trivalent metal cations,

or a mixture of a plurality of salts of the formulae I to IIIj.

Preferred ionic liquids have, as cations, substituted or unsubstituted, preferably substituted, ammonium, phosphonium, pyridinium or imidazolium cations.

The ionic liquids which are used with preference in accordance with the invention preferably comprise at least one cation of the general formulae:

R¹R²R³R⁴N⁺ (IV)

R¹R²N⁺=CR³R⁴ (V)

R¹R²R³R⁴P⁺ (VI)

R¹R²P⁺=CR³R⁴ (VII)

R¹R²R³S+ (VIII)

in which

R¹, R², R³, R⁴ are the same or different and are each hydrogen, a linear or branched aliphatic hydrocarbon radical which has 1 to 30 carbon atoms and may contain double bonds, a cycloaliphatic hydrocarbon radical which has 5 to 40 carbon atoms and may contain double bonds, an aromatic hydrocarbon radical having 6 to 40 carbon atoms, an alkylaryl radical having 7 to 40 carbon atoms, a linear or branched aliphatic hydrocarbon radical which has 2 to 30 carbon atoms and is interrupted by one or more heteroatoms (oxygen, NH, NR′ where R′ is a C₁-C₃₀-alkyl radical which may contain double bonds, especially —CH₃) and may contain double bonds, a linear or branched aliphatic hydrocarbon radical which has 2 to 30 carbon atoms and is interrupted by or more functions selected from the group of —O—C(O)—, —(O)C—O—, —NH—C(O)—, —(O)C—NH, —(CH₃)N—C(O)—, —(O)C—N(CH₃)—, —S(O₂) —O—, —O—S(O₂)—, —S(O₂)—NH—, —NH—S(O₂)—, —S(O₂)—N (CH₃)—, —N(CH₃) —S(O)—, and may contain double bonds, a terminally OH—, OR′—, NH₂—, N(H)R′—, N(R′)₂-functionalized (where R′ is a C₁-C₃₀-alkyl radical which may contain double bonds), linear or branched, aliphatic or cycloaliphatic hydrocarbon radical which has 1 to 30 carbon atoms and may contain double bonds or a polyether with blockwise or random structure of the formula —(R⁵—O)ₙ-R⁶, where

R⁵ is a linear or branched hydrocarbon radical containing 2 to 4 carbon atoms,

n is 1 to 100, preferably 2 to 60, and

R⁶ is hydrogen, a linear or branched aliphatic hydrocarbon radical which has 1 to 30 carbon atoms and may contain double bonds, a cycloaliphatic hydrocarbon radical which has 5 to 40 carbon atoms and may contain double bonds, an aromatic hydrocarbon radical having 6 to 40 carbon atoms, an alkylaryl radical or arylalkyl radical having 7 to 40 carbon atoms or a —C(O)—R⁷ radical where

R⁷ is a linear or branched aliphatic hydrocarbon radical which has 1 to 30 carbon atoms and may contain double bonds, a cycloaliphatic hydrocarbon radical which has 5 to 40 carbon atoms and may contain double bonds, an aromatic hydrocarbon radical having 6 to 40 carbon atoms, an alkylaryl radical or arylalkyl radical having 7 to 40 carbon atoms.

As cations, the ionic liquid may likewise contain those derived from saturated or unsaturated cyclic compounds or from aromatic compounds having in each case at least one trivalent nitrogen atom in a 4- to 10-membered, preferably 5- or 6-membered, heterocyclic ring which may optionally be substituted. Such cations can be described in simplified form (i.e. without indication of the exact position and number of the double bonds in the molecule) by the general formulae (IX), (X) and (XI) below, where the heterocyclic rings may also contain a plurality of heteroatoms:

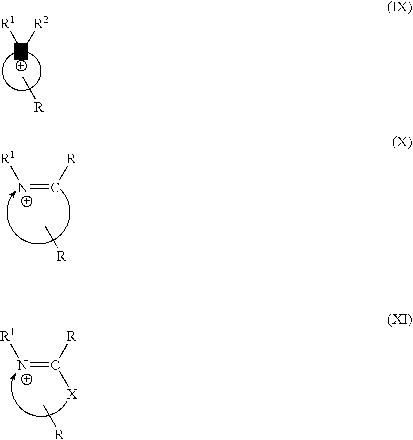

where

R¹ and R² are each as defined above,

R may be a hydrogen, a linear or branched aliphatic hydrocarbon radical which has 1 to 30 carbon atoms and may contain double bonds, a cycloaliphatic hydrocarbon radical which has 5 to 40 carbon atoms and may contain double bonds, an aromatic hydrocarbon radical having 6 to 40 carbon atoms or an alkylaryl radical or arylalkyl radical having 7 to 40 carbon atoms.

X may be an oxygen atom, a sulphur atom or a substituted nitrogen atom (X=O, S, NR¹).

Examples of cyclic nitrogen compounds of the aforementioned type are pyrrolidine, dihydropyrrole, pyrrole, imidazoline, oxazoline, oxazole, thiazoline, thiazole, isoxazole, isothiazole, indole, carbazole, piperidine, pyridine, the isomeric picolines and lutidines, quinoline and isoquinoline. The cyclic nitrogen compounds of the general formulae (IX), (X) and (XI) may be unsubstituted (R=H) or monosubstituted or polysubstituted by the R radical, and, in the case of polysubstitution by R, the individual R radicals may be different.

As cations, the ionic liquid may also contain those ions derived from saturated acyclic, saturated or unsaturated cyclic compounds or from aromatic compounds having in each case more than one trivalent nitrogen atom in a 4- to 10-membered, preferably 5- or 6-membered, heterocyclic ring. These compounds may be substituted both on the carbon atoms and on the nitrogen atoms. They may also be fused with unsubstituted or substituted benzene rings and/or cyclohexane rings to form polycyclic structures. Examples of such compounds are pyrazole, 3,5-dimethylpyrazole, imidazole, benzimidazole, N-methylimidazole, dihydropyrazole, pyrazolidine, pyridazine, pyrimidine, pyrazine, 2,3-, 2,5- and 2,6-dimethylpyrazine, cinnoline, quinoline, phthalazine, quinazoline, phenazine and piperazine. Especially cations derived from imidazole and its alkyl and phenyl derivatives have been found to be useful as constituents of ionic liquids.

As cations, the ionic liquid may likewise contain cations which contain two nitrogen atoms and are represented by the general formula (XII)

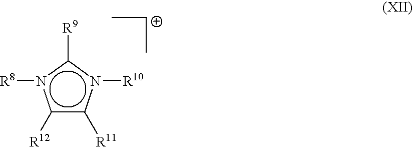

in which

R⁸, R⁹, R¹⁰, R¹¹, R¹² are the same or different and are each hydrogen, a linear or branched aliphatic hydrocarbon radical which has 1 to 30 carbon atoms and may contain double bonds, a cycloaliphatic hydrocarbon radical which has 5 to 40 carbon atoms and may contain double bonds, an aromatic hydrocarbon radical having 6 to 40 carbon atoms, an alkylaryl radical or arylalkyl radical having 7 to 40 carbon atoms, a linear or branched aliphatic hydrocarbon radical which has 1 to 30 carbon atoms and is interrupted by one or more heteroatoms (oxygen, NH, NR′ where R′ is a C₁-C₃₀-alkyl radical which may contain double bonds) and may contain double bonds, a linear or branched aliphatic hydrocarbon radical which has 1 to 30 carbon atoms and is interrupted by one or more functions selected from the group of —O—C(O)—, —(O)C—O—, —NH—C(O)—, —(O)C—NH, —(CH₃)N—C(O)—, —(O)C—N(CH₃)—, —S(O)—O—, —O—S(O)—S(O₂)—NH—, —NH—S(O₂)—, —S(O₂)—N(CH₃)—, —N(CH₃)—S(O₂)—, and may contain double bonds, a terminally OH—, OR′—, NH₂—, N(H)R′—, N(R′)₂-functionalized (where R′ is a C₁-C₃₀-alkyl radical which may contain double bonds), linear or branched, aliphatic or cycloaliphatic hydrocarbon radical which has 1 to 30 carbon atoms and may contain double bonds or a polyether with blockwise or random structure of the formula —(R⁵—O)ₙ-R⁶,

where

R⁵ is a hydrocarbon radical containing 2 to 4 carbon atoms,

n is 1 to 100 and

R⁶ is hydrogen, a linear or branched aliphatic hydrocarbon radical which has 1 to 30 carbon atoms and may contain double bonds, a cycloaliphatic hydrocarbon radical which has 5 to 40 carbon atoms and may contain double bonds, an aromatic hydrocarbon radical having 6 to 40 carbon atoms, an alkylaryl radical having 7 to 40 carbon atoms or a —C(O)—R⁷ radical where

R⁷ is a linear or branched aliphatic hydrocarbon radical which has 1 to 30 carbon atoms and may contain double bonds, a cycloaliphatic hydrocarbon radical which has 5 to 40 carbon atoms and may contain double bonds, an aromatic hydrocarbon radical having 6 to 40 carbon atoms, an alkylaryl radical having 7 to 40 carbon atoms.

As cations of the formula (XII), the ionic liquids more preferably contain imidazolium ions selected from 1-methylimidazolium, 1-ethylimidazolium, 1- (1-butyl)-imidazolium, 1-(1-octyl)imidazolium, 1-(1-dodecyl)-imidazolium, 1-(1-tetradecyl)imidazolium, 1-(1-hexadecyl)-imidazolium, 1,3-dimethylimidazolium, 1-ethyl-3-methyl-imidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(l-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethyl-imidazolium, 1,4,5-trimethyl-3-butylimidazolium and 1,4,5-trimethyl-3-octylimidazolium.

As cations, the ionic liquid may likewise contain ions which, in particular, form dications, trications or polycations from the aforementioned cations as a result of dimerization, trimerization or polymerization. The cations, especially dications, trications and polycations, may also be those which have a polymeric backbone, for example one based on siloxanes, polyethers, polyesters, polyamides or polyacrylates, in particular branched and hyperbranched polymers.

Preference is given to using quaternary ammonium salts of alkoxylated fatty acids—also known as alkanolamine ester quats—characterized by the generic formula of the R¹R²R³R⁴N⁺A⁻(IV) type, in which R¹ is an alkyl radical having 1 to 20 carbon atoms, R² is an alkyl radical having 1 to 4 carbon atoms, R³ is a (CH₂CHRO)ₙ—H radical where n is 1 to 200 and R is H or CH₃, R⁴ is an alkyl radical having 1 to 4 carbon atoms or a (CH₂CHRO)ₙ—H radical where n is 1 to 200, and R is H or CH₃, and A⁻ is a monovalent anion.

Among these compounds, substances of the formula

(i) R⁶₄₋ₘN⁺[(CH₂)ₙ-Q-R^{7]}ₘX⁻

are preferred, where

each R⁶ radical is independently an alkyl group or hydroxyalkyl group having 1 to 6 carbon atoms, or a benzyl group and preferably a methyl group,

R⁷ is independently hydrogen, a linear or branched alkyl group having 11 to 22 carbon atoms, a linear or branched alkenyl group having 11 to 22 carbon atoms, with the condition that at least one R⁷ radical is not hydrogen,

Q is independently selected from the groups of the formulae —O—C(O)—, —C(O)O, —NR⁸—C(O)—, —C(O)—NR⁸—, —O—C(O)—O, —CHR⁹—O—C(O)—or —CH(OCOR⁷)—CH₂—O—C(O)—, where

R⁸ is hydrogen or a methyl, ethyl, propyl or butyl radical and R⁹ is hydrogen or methyl and Q is preferably —O—C(O)— or —NH—C(O)—;

m is 1 to 4 and preferably 2 or 3;

n is 1 to 4 and preferably 2;

X is an anion compatible with the application, for example methylsulphate, ethylsulphate, methylsulphonate, butylsulphate, octylsulphate, phosphinate or 2-(2-methoxyethoxy)ethylsulphate, preferably methylsulphate, 2-(2-methoxyethoxy)ethylsulphate, octylsulphate and phosphinate.

The quaternary ammonium compound may comprise mixtures of the compounds with different R⁷ groups which are not hydrogen, whose value ranges from 1 up to m. Preferably, such mixtures comprise an average of 1.2 to 2.5 R⁷ groups which are not hydrogen. The proportion of the non-hydrogen R⁷ groups is preferably 1.4 to 2.0 and preferentially 1.6 to 1.9.

The preferred quaternary ammonium compounds are the compounds of the type:

(ii) R⁶N⁺[CH₂CHR⁹OH—] [CH₂CHR⁹OC(O)R^{7]}₂X⁻

(iii) R⁶N⁺[CH₂CHR⁹OC(O)R^{7]}₂X⁻

(iv) R⁶N⁺[CH₂CHR⁹OH—] [CH₂CH₂NHC(O)R^{7]}₂X⁻,

where R⁶, R⁷ and X are each as defined for formula (i) above.

The —C(O)R⁷ fragment is preferably a fat-containing acyl group. Usable fat-containing acyl groups are derived from the natural sources of the triglycerides, preferably tallow, vegetable oils, partly hydrogenated tallow and partly hydrogenated vegetable oils. Usable sources of the triglycerides are, for example, soybean oil, tallow, partially hydrogenated tallow, palm oil, palm kernels, rapeseeds, porcine fat, coconut, rape, safflower oil, maize, rice and tall oil, and mixtures of these components.

The person skilled in the art is aware that the composition of the fatty acid-containing compounds is subject to certain natural variations, depending on the harvest or on the variety of the vegetable oil sources. The R⁷ groups are usually mixtures of the linear and branched carbon chains of the saturated and unsaturated aliphatic fatty acids.

The proportion of unsaturated R⁷ groups in such mixtures is preferably at least 10%, more preferably at least 25% and most preferably 40% to 70%. The proportion of polyunsaturated R⁷ groups in such mixtures is less than 10%, preferably less than 5% and more preferably less than 3%. If required, partial hydrogenation can be carried out in order to raise the saturated character and hence to improve the stability (for example odour, colour, etc.) of the end product. The content of unsaturated fractions, expressed by the iodine number, should be within a range of 5 to 150 and preferably within a range of 5 to 50. The ratio of cis and trans isomers of the double bonds in the unsaturated R⁷ groups is preferably greater than 1:1 and more preferably in the range of 4:1 to 50:1.

Preferred examples of the compounds of the formula (i) are: N,N-di(tallowyloxyethyl)-N,N-dimethylammonium chloride; N,N-di(canolyloxyethyl)-N,N-dimethylammonium chloride; N,N-di(tallowyloxyethyl)-N-methyl,N-(2-hydroxy-ethyl)ammonium methylsulphate; N,N-di(canolyloxyethyl)-N-methyl,N-(2-hydroxyethyl)ammonium methylsulphate; N,N-di(tallowylamidoethyl)-N-methyl,N-(2-hydroxyethyl)-ammonium methylsulphate; N,N-di(2-tallowyloxy-2-oxo-ethyl)-N,N-dimethylammonium chloride; N,N-di(2-canolyl-oxy-2-oxo-ethyl)-N,N-dimethylammonium chloride; N,N-di(2-tallowyloxyethylcarbonyloxyethyl)-N,N-dimethyl-ammonium chloride; N,N-di(2-canolyloxyethylcarbonyl-oxyethyl)-N,N-dimethylammonium chloride; N-(2-tallowyl-oxy-2-ethyl)-N-(2-tallowyloxy-2-oxoethyl)-N,N-dimethyl-ammonium chloride; N-(2-canolyloxy-2-ethyl)-N-(2-canolyl-oxy-2-oxoethyl)-N,N-dimethylammonium chloride; N,N,N-tri-(tallowyloxyethyl)-N-methylammonium chloride; N,N,N-tri-(canolyloxyethyl)-N-methylammonium chloride; 1,2-ditallowyloxy-3-N,N,N-trimethylammoniumpropyl chloride; and 1,2-dicanolyloxy-3-N,N,N-trimethylammoniumpropyl chloride.

Further preferred quaternary ammonium salts are ditallowdimethylammonium chloride, ditallowdimethylammonium methylsulphate, dimethylammonium chloride, di(hydrogenated tallow)distearyldimethylammonium chloride and dibehenyldimethylammonium chloride.

In a preferred embodiment of the present invention, the ionic liquids used in the cleaning composition are those in which the cation [A]⁺ is a pyridinium ion (XIIIa)

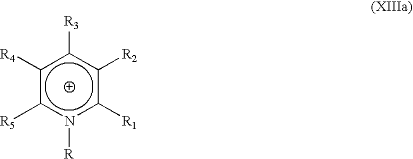

in which

R is as defined above for formula IX, one of the R₁ to R₅ radicals is methyl, ethyl or chlorine and the remaining R₁ to R₅ radicals are each hydrogen;

R₃ is dimethylamino and the remaining R₁, R₂, R₄ and R₅ radicals are each hydrogen; all R₁ to R₅ radicals are each hydrogen;

R₂ is carboxyl or carboxamide and the remaining R₁, R₂, R₄ and R₅ radicals are each hydrogen; or

R₁ and R₂ or R₂ and R₃ are 1,4-buta-1,3-dienylene and the remaining R₁, R₂, R₄ and R₅ radicals are each hydrogen. The cation [A]⁺ is preferably a pyridinium ion (XIIIa) in which

R₁ to R₅ are each hydrogen; or one of the R₁ to R₅ radicals is methyl or ethyl and the remaining R₁ to R₅ radicals are each hydrogen.

The ionic liquid most preferably has, as the cation, a pyridinium ion (XIIIa) selected from 1-methylpyridinium, 1-ethylpyridinium, 1-(1-butyl)pyridinium, 1-(1-hexyl)-pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethyl-pyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethylpyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethylpyridinium.

In a further preferred embodiment of the present invention, the ionic liquids used in the cleaning composition are those in which the cation [A]⁺ is a pyridazinium ion (XIIIb)

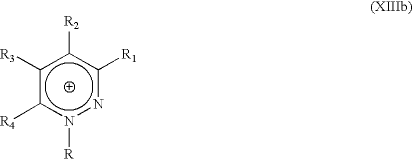

in which

R₁ to R₄ are each hydrogen, or one of the R₁ to R₄ radicals is methyl or ethyl and the remaining R₁ to R₄ radicals are each hydrogen,

R is as defined above for formula IX.

In a further preferred embodiment of the present invention, the ionic liquids used in the cleaning composition are those in which the cation [A]⁺ is a pyrimidinium ion (XIIIc)

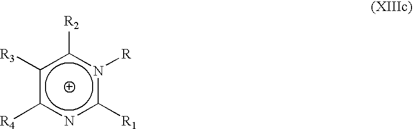

in which

R₁ is hydrogen, methyl or ethyl and

R₂ to R₄ are each independently hydrogen or methyl or

R₁ is hydrogen, methyl or ethyl,

R₂ and R₄ are each methyl and

R₃ is hydrogen,

R is as defined above for formula IX.

In a further preferred embodiment of the present invention, the ionic liquids used in the cleaning composition are those in which the cation [A]⁺ is a pyrazinium ion (XIIId)

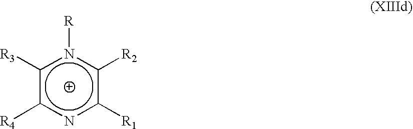

where

R₁ is hydrogen, methyl or ethyl and

R₂ to R₄ are each independently hydrogen or methyl,

R₁ is hydrogen, methyl or ethyl,

R₂ and R₄ are each methyl and

R₃ is hydrogen,

R₁ to R₄ are each methyl or

R₁ to R₄ are each methyl or hydrogen,

R is as defined above for formula IX.

In a further preferred embodiment of the present invention, the ionic liquids used in the cleaning composition are those in which the cation [A]⁺ is a pyrazolium ion (XIIIf), (XIIIg) or (XIIIg′)

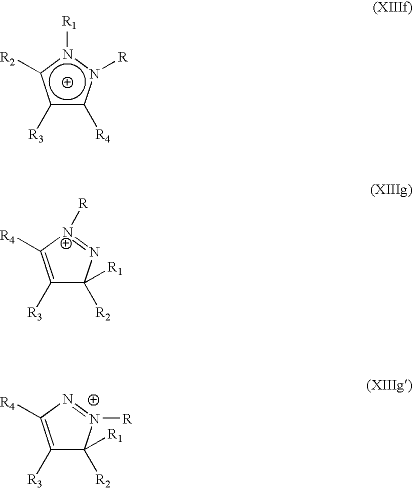

where

R₁ is hydrogen, methyl or ethyl and

R₂ to R₄ are each independently hydrogen or methyl,

R is as defined above for formula IX.

In a further preferred embodiment of the present invention, the ionic liquids used in the cleaning composition are those in which the cation [A]⁺ is a pyrazolium ion (XIIIh)

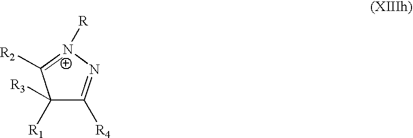

in which

R₁ to R₄ are each independently hydrogen or methyl.

In a further preferred embodiment of the present invention, the ionic liquids used in the cleaning composition are those in which the cation [A]⁺ is a 1-pyrazolinium ion (XIIIi)

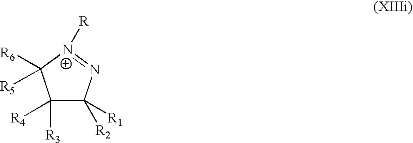

in which

R₁ to R₆ are each independently hydrogen or methyl,

R is as defined above for formula IX.

In a further preferred embodiment of the present invention, the ionic liquids used in the cleaning composition are those in which the cation [A]⁺ is a 2-pyrazolinium ion (XIIIj)

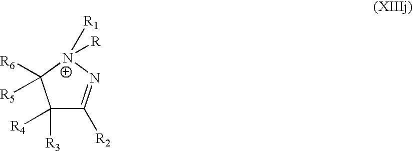

in which

R₁ is hydrogen, methyl, ethyl or phenyl and

R₂ to R₆ are each independently hydrogen or methyl.

In a further preferred embodiment of the present invention, the ionic liquids used in the cleaning composition are those in which the cation [A]⁺ is a 3-pyrazolinium ion (XIIIk) or (XIIIk′)

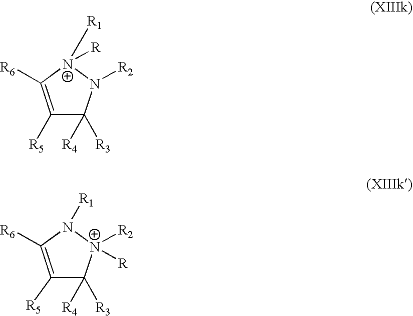

in which

R₁ and R₂ are each independently hydrogen, methyl, ethyl or phenyl and

R₃ to R₆ are each independently hydrogen or methyl.

R is as defined above for formula IX.

In a further preferred embodiment of the present invention, the ionic liquids used in the cleaning composition are those in which the cation [A]⁺ is an imidazolinium ion (XIIIl)

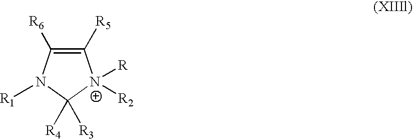

in which

R₁ and R₂ are each independently hydrogen, methyl, ethyl, 1-butyl or phenyl,

R₃ and R₄ are each independently hydrogen, methyl or ethyl and

R₅ and R₆ are each independently hydrogen or methyl.

In a further preferred embodiment of the present invention, the ionic liquids used in the cleaning composition are those in which the cation [A]⁺ is an imidazolinium ion (XIIIm) or (XIIIm′)

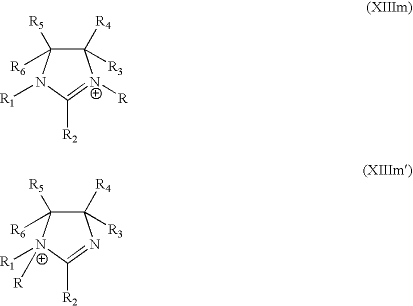

in which

R₁ and R₂ are each independently hydrogen, methyl or ethyl and

R₃ to R₆ are each independently hydrogen or methyl,

R is as defined above for formula IX.

In a further preferred embodiment of the present invention, the ionic liquids used in the cleaning composition are those in which the cation [A]⁺ is an imidazolinium ion (XIIIn) or (XIIIn′)

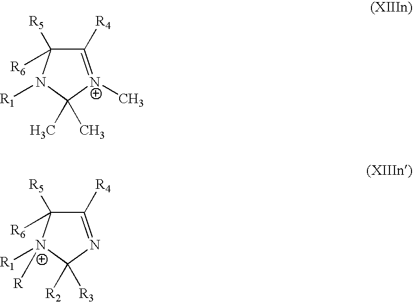

in which

R₁ to R₃ are each independently hydrogen, methyl or ethyl and

R₄ to R₆ are each independently hydrogen or methyl,

R is as defined above for formula IX.

In a further preferred embodiment of the present invention, the ionic liquids used in the cleaning composition are those in which the cation [A]⁺ is a thiazolium ion (XIIIo) or (XIIIo′) or an oxazolium ion (XIIIp)

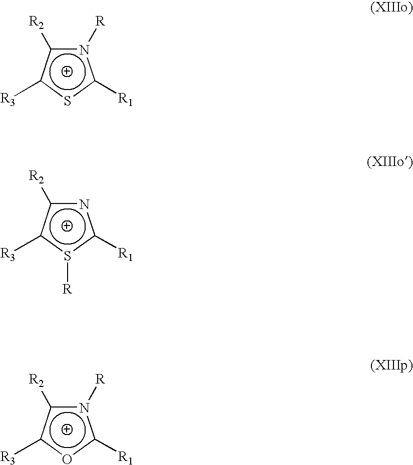

in which

R₁ is hydrogen, methyl, ethyl or phenyl and

R₂ and R₃ are each independently hydrogen or methyl,

R is as defined above for formula IX.

In a further preferred embodiment of the present invention, the ionic liquids used in the cleaning composition are those in which the cation [A]⁺ is a 1,2,4-triazolium ion (XIIIq), (XIIIq′) or (XIIIq″)

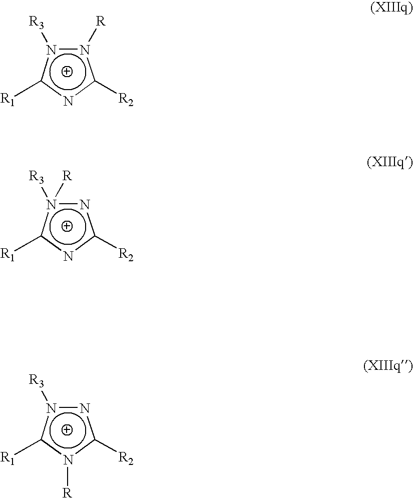

in which

R₁ and R₂ are each independently hydrogen, methyl, ethyl or phenyl and

R₃ is hydrogen, methyl or phenyl,

R is as defined above for formula IX.

In a further preferred embodiment of the present invention, the ionic liquids used in the cleaning composition are those in which the cation [A]⁺ is a 1,2,3-triazolium ion (XIIIr), (XIIIr′) or (XIIIr″)

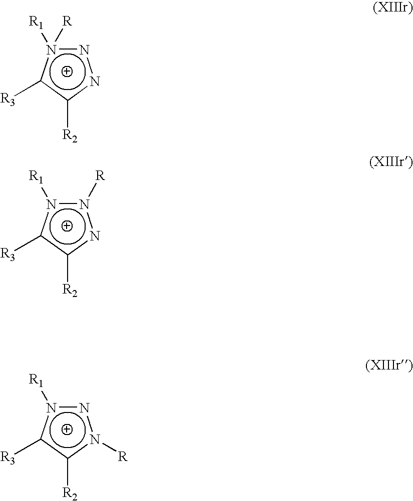

in which

R₁ is hydrogen, methyl or ethyl and

R₂ and R₃ are each independently hydrogen or methyl or R₂ and R₃ together are 1,4-buta-1,3-dienylene,

R is as defined above for formula IX.

In a further preferred embodiment of the present invention, the ionic liquids used in the cleaning composition are those in which the cation [A]⁺ is a pyrrolidinium ion (XIIIs)

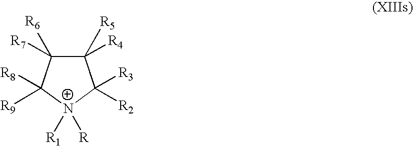

in which

R₁ is hydrogen, methyl, ethyl or phenyl and

R₂ to R₉ are each independently hydrogen or methyl,

R is as defined above for formula IX.

In a further preferred embodiment of the present invention, the ionic liquids used in the cleaning composition are those in which the cation [A]⁺ is an imidazolidinium ion (XIIIt)

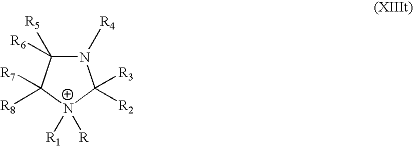

in which

R₁ and R₄ are each independently hydrogen, methyl, ethyl or phenyl and

R₂ and R₃ and also R₅ to R₈ are each independently hydrogen or methyl,

R is as defined above for formula IX.

In a further preferred embodiment of the present invention, the ionic liquids used in the cleaning composition are those in which the cation [A]⁺ is an ammonium ion (IV)

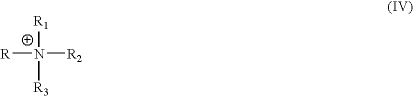

in which

R is as defined above for formula IX,

R₁ to R₃ are each independently C₁-C₁₈-alkyl or

R₁ to R₃ are each independently hydrogen or C₁-C₁₈-alkyl and

R₄ is 2-hydroxyethyl, or

R₁ and R₂ together are 1,5-pentylene or 3-oxa-1,5-pentylene and

R₃ is C₁-C₁₈-alkyl, 2-hydroxyethyl or 2-cyanoethyl.

Particularly preferred ammonium ions (IV) include, in particular, methyltri(1-butyl)ammonium, 2-hydroxyethyl-ammonium, bis(2-hydroxyethyl)dimethylammonium, N,N-di-methylpiperidinium and N,N-dimethylmorpholinium.

In a further preferred embodiment of the present invention, the ionic liquids used in the cleaning composition are those in which the cation [A]⁺ is a guanidinium ion (IVv),

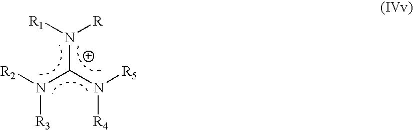

in which

R is as defined above for formula IX,

R₁ to R₅ are each methyl,

R₁ to R₅ are each independently C₁-C₁₈-alkyl or

R₁ to R₅ are each independently hydrogen or C₁-C₁₈-alkyl or 2-hydroxyethyl.

A very particularly preferred guanidinium ion (IVv) is N,N,N′,N′,N″,N″-hexamethylguanidinium.

In a further preferred embodiment of the present invention, the ionic liquids used in the cleaning composition are those in which the cation [A]⁺ is a derivative of an ethanolamine, e.g. a cholinium ion (XIIIw), or of a diethanolamine (XIIIw′) or of a triethanolamine (XIIIw″)

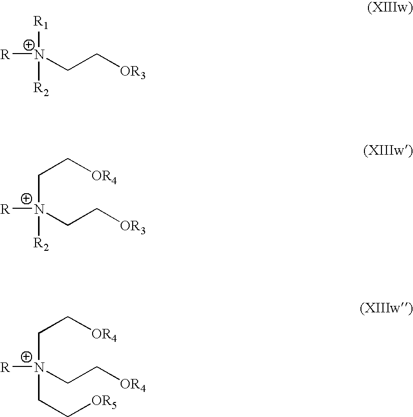

in which

R is as defined above for formula IX,

R₁ and R₂ are each independently methyl, ethyl, 1-butyl or 1-octyl and

R₃ is hydrogen, methyl, ethyl, acetyl, —SO₂OH or —PO(OH)₂, or

R₁ is methyl, ethyl, 1-butyl or 1-octyl, R₂ is a —CH₂-CH₂—OR₄ group and

R₃ and R₄ are each independently hydrogen, methyl, ethyl, acetyl, -SO₂OH or —PO(OH)₂, or

R₁ is a —CH₂-CH₂—OR₄ group,

R₂ is a —CH₂-CH₂—OR5 group and

R₃ to R₅ are each independently hydrogen, methyl, ethyl, acetyl, —SO20H or —PO(OH)₂, or

R₁ is methyl, ethyl, 1-butyl, 1-octyl, acetyl, —SO₂OH, or —PO(OH)₂ and

R₃ to R₅ are each independently hydrogen, methyl, ethyl, acetyl, —SO₂OH, —PO(OH)₂, or —(CₙH₂ₙO)ₘR₁ where

n=1 to 5 and

m=1 to 100.

In a further preferred embodiment of the present invention, the ionic liquids used in the cleaning composition are those in which the cation [A]⁺ is a phosphonium ion (VI) in which R₁ to R₃ are each independently C₁-C₁₈-alkyl, in particular butyl, isobutyl, 1-hexyl or 1-octyl.

Among the abovementioned cations, the pyridinium ions (XIIIa), imidazolium ions (XII) and ammonium ions (IV) are particularly preferred as cations. Most preferably, the ionic liquids used in the inventive cleaning compositions are those which have one or more cations selected from 1-methylpyridinium, 1-ethylpyridinium, 1-(1-butyl)pyridinium, 1-(1-hexyl)pyridinium, 1-(1-octyl)-pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methyl-pyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetra-decyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, and 1-(1-octyl)-2,3-dimethylimidazolium, 1,4-dimethylimidazolium, 1,3,4-trimethylimidazolium, 1,4-dimethyl-3-ethylimidazolium, 3-butyl-imidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 2-hydroxyethylammonium as cations.

The metal cations [M^{1]+}, [M^{2]+}, [M^{3]+}, [M^{4]2+} and [M^{5]3+} mentioned in the formulae (IIIa) to (IIIj) are preferably metal cations of groups 1, 2, 6, 7, 8, 9, 10, 11, 12 and 13 of the Periodic Table. Particularly preferred metal cations are, for example, Li⁺, Na⁺, K⁺, Cs⁺, Mg²⁺, Ca²⁺, Ba²⁺, Cr³⁺, Fe²⁺, Fe³⁺, Co²⁺, Ni²⁺, Cu²⁺, Ag⁺, Zn²⁺ and Al³⁺.

The ionic liquids used with preference in accordance with the invention consist of at least one of the above-mentioned cations combined with at least one anion in each case. Usable anions are in principle all anions which, in conjunction with the cation, lead to an ionic liquid.

The anion [Y]ⁿ⁻ of the ionic liquid may, for example, be selected from:

the group of halides and halogen-containing and halogen-like compounds of the formulae: F⁻, Cl⁻, Br⁻, I⁻, BF₄⁻, PF₆⁻, AlCl₄⁻, Al₂Cl₇⁻, Al₃Cl₁₀⁻, AlBr₄⁻, FeCl₄⁻, BCl₄⁻, SbF₆⁻, AsF₆⁻, ZnCl₃⁻, SnCl₃⁻, CuCl₂⁻, CF₃SO₃⁻, (CF₃SO₃⁻)₂N⁻, CF₃CO₂⁻, CCl₃CO₂⁻, CN⁻, SCN⁻, OCN⁻, NO₂⁻, NO₃⁻, N(CN)⁻;

the group of sulphates, sulphites and sulphonates of the general formulae: SO₄²⁻, HSO₄⁻, SO₃²⁺, HSO₃⁻, R^{a}OSO₃₋, R^{a}SO₃⁻;

the group of phosphates of the general formulae: PO₄³⁻, HPO₄²⁻, H₂PO⁴⁻, R^{a}PO₄²⁻, HR^{a}PO₄⁻, R^{a}R^{b}PO₄⁻;

the group of phosphonates and phosphinates of the general formulae: R^{a}HPO₃⁻, R^{a}R^{b}PO₂⁻, R^{a}R^{b}PO₃⁻;

the group of phosphites of the general formulae: PO₃³⁻, HPO₃²⁻, H₂PO₃²⁻, R^{a}PO₃²⁻, R^{a}HPO₃⁻, R^{a}R^{b}PO₃⁻;

the group of phosphonites and phosphinites of the general formulae: R^{a}R^{b}PO₂⁻, R^{a}HPO₂⁻, R^{a}R^{b}PO⁻, R^{a}HPO⁻;

the group of carboxylates of the general formula: R^{a}COO⁻;

the group of borates of the general formulae: BO₃³⁻, HBO₃²⁻, H₂BO₃⁻, R^{a}R^{b}BO₃⁻, R^{a}HBO₃⁻, R^{a}BO₃²⁻, B(OR^{a}) (OR^{b}) (OR^{c}) (OR^{d})⁻, B(HSO₄)⁻, B(R^{a}SO₄)⁻;

the group of boronates of the general formulae: R^{a}BO₂²⁻, R^{a}R^{b}BO⁻;

the group of carbonates and carbonic esters of the general formulae: HCO₃⁻, CO₃²⁻, R^{a}CO₃⁻;

the group of silicates and silicic esters of the general formulae: SiO₄⁻, HSiO₄³⁻, H₂SiO₄²⁻, H₃SiO₄₋, R^{a}SiO₄³⁻, R^{a}R^{b}SiO₄²⁻, R^{a}R^{b}R^{c}SiO₄²⁻, HR^{a}SiO₄²⁻, H₂R^{a}SiO₄⁻, HR^{a}R^{b}SiO₄⁻;

the group of alkylsilane or arylsilane salts of the general formulae: R^{a}SiO₃³, R^{a}R^{b}SiO₂²⁻, R^{a}R^{b}R^{c}SiO⁻, R^{a}R^{b}R^{c}SiO₃⁻, R^{a}R^{b}R^{c}SiO₃²⁻, R^{a}R^{b}SiO₃²⁻;

the group of carboximides, bis(sulphonyl)imides and sulphonylimides of the general formulae:

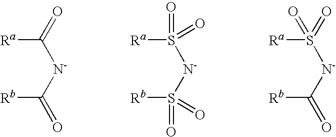

the group of methides of the general formula:

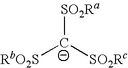

the group of alkoxides and aryl oxides of the general formula: R^{a}O⁻;

the group of the halometallates of the general formula [MᵣHal_{t]}^{s-}, where M is a metal and Hal is fluorine, chlorine, bromine or iodine, r and t are positive integers and indicate the stoichiometry of the complex and s is a positive integer and indicates the charge of the complex;

the group of sulphides, hydrogensulphides, polysulphides, hydrogenpolysulphides and thiolates of the general formulae: S²⁻, HS⁻, [Sᵥ^{]2-}, [HSᵥ^{]-}, [R^{a}S]⁻, where v is a positive integer from 2 to 10;

the group of complex metal ions such as Fe(CN)₆³⁻, Fe(CN)₆⁴⁻, MnO₄⁻, Fe(CO)₄⁻,

where R^{a}, R^{b}, R^{c} and R^{d} may each independently be: hydrogen;

C₁-C₃₀-alkyl or an aryl-, heteroaryl-, cycloalkyl-, halogen-, hydroxy-, amino-, carboxyl-, formyl-, —O—, —CO—, —CO—O— or —CO—N-substituted derivative thereof, for example methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-l-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, triacontyl, phenylmethyl (benzyl), diphenylmethyl, triphenylmethyl, 2-phenylethyl, 3-phenylpropyl, cyclopentylmethyl, 2-cyclopentylethyl, 3-cyclopentylpropyl, cyclohexylmethyl, 2-cyclohexylethyl, 3-cyclohexylpropyl, methoxy, ethoxy, formyl, acetyl or C_{q}F_{2(q-a)+(1-b)}H_{2a+b} where q<30, 0 ≦a≦q and b=0 or 1 (for example CF₃, C₂F₅, CH₂CH₂-C_{(q-2)}F_{2(q-2)+1}, C₆F₁₃, C₈F₁₇, C₁₀F₂₁, C₁₂F₂₅);

C₃-C₁₂-cycloalkyl or an aryl-, heteroaryl-, cycloalkyl-, halogen-, hydroxy-, amino-, carboxy-, formyl-, —O—, —CO— or —CO——O—-substituted derivative thereof, for example cyclopentyl, 2-methyl-1-cyclopentyl, 3-methyl-1-cyclopentyl, cyclohexyl, 2-methyl-1-cyclohexyl, 3-methyl-1-cyclohexyl, 4-methyl-1-cyclohexyl or C_{q}F_{2(q-a)-(1-b)}H_{2a-b} where q≦30, 0 ≦a≦q and b=0 or 1;

C₂-C₃₀-alkenyl or an aryl-, heteroaryl-, cycloalkyl-, halogen-, hydroxy-, amino-, carboxy-, formyl-, —O—, —CO— or —CO—O—-substituted derivative thereof, for example 2-propenyl, 3-butenyl, cis-2-butenyl, trans-2-butenyl or C_{q}F_{2(q-a)-(1-b)}H_{2a-b} where q≦30, 0 ≦a≦q and b=0 or 1;

C₃-C₁₂-cycloalkenyl or an aryl-, heteroaryl-, cycloalkyl-, halogen-, hydroxy-, amino-, carboxy-, formyl-, —O—, —CO— or —CO—O—-substituted analogues thereof, for example 3-cyclopentenyl, 3-cyclohexenyl, 3-cyclohexenyl, 2,5-cyclohexadienyl or C_{q}F_{2(q-a)-3(1-b)}H_{2a-3b} where q≦30, 0 ≦a≦q and b=0 or 1;

aryl or heteroaryl having from 2 to 30 carbon atoms or an alkyl-, aryl-, heteroaryl-, cycloalkyl-, halogen-, hydroxy-, amino-, carboxy-, formyl-, —O—, —CO— or —CO—O—-substituted analogues thereof, for example phenyl, 2-methylphenyl (2-tolyl), 3-methylphenyl (3-tolyl), 4-methylphenyl, 2-ethylphenyl, 3-ethylphenyl, 4-ethylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 4-phenylphenyl, 1-naphthyl, 2-naphthyl, 1-pyrrolyl, 2-pyrrolyl, 3-pyrrolyl, 2-pyridinyl, 3-pyridinyl, 4-pyridinyl or C₆F₍₅₋ₐ₎Hₐ where 0 ≦a≦5; or

two radicals form an unsaturated, saturated or aromatic ring which may be substituted by functional groups, aryl, alkyl, aryloxy, alkyloxy, halogen, heteroatoms and/or heterocycles and may be interrupted by one or more oxygen and/or sulphur atoms and/or one or more substituted or unsubstituted imino groups.

The ionic liquids used in accordance with the invention preferably have anions selected from halides, carboxylates, phosphates, thiocyanates, isothiocyanates, dicyanamides, sulphates, alkylsulphates, sulphonates, alkylsulphonates, tetrafluoroborate, hexafluorophosphate and bis(trifluoromethylsulphonyl)imide.

Preferred anions are chloride, bromide, iodide, thiocyanate, hexafluorophosphate, trifluoromethanesulphonate, methanesulphonate, formate, acetate, glycolate, lactate, mandelate, nitrate, nitrite, trifluoroacetate, sulphate, hydrogensulphate, methylsulphate, ethylsulphate, 1-propylsulphate, 1-butylsulphate, 1-hexylsulphate, 1-octylsulphate, phosphate, dihydrogenphosphate, hydrogenphosphate, C₁-C₄-dialkylphosphates, propionate, tetrachloroaluminate, Al₂Cl₇⁻, chlorozincate, chloroferrate, bis(trifluoromethylsulphonyl)imide, bis(pentafluoroethylsulphonyl)imide, bis(methylsulphonyl)imide, bis(p-toluenesulphonyl)imide, tris(trifluoromethylsulphonyl)methide, bis(pentafluoroethylsulphonyl)methide, p-toluenesulphonate, tetracarbonyl cobaltate, dimethylene glycol monomethyl ether sulphate, oleate, stearate, acrylate, methacrylate, maleate, hydrogencitrate, vinylphosphonate, bis(pentafluoroethyl)phosphinate, borates such as bis[salicylato(2-)]borate, bis[oxalato(2-)]-borate, bis[1,2-benzoldiolato(2-)—O,O′]borate, tetracyanoborate, tetrafluoroborate, dicyanamide, tris(pentafluoroethyl)trifluorophosphate, tris(heptafluoropropyl)-trifluorophosphate, cyclic arylphosphates such as catecholphosphate (C₆H₄O₂)P(O)O⁻ or chlorocobaltate.

Particularly preferred anions are anions from the group consisting of halides, bis(perfluoroalkylsulphonyl)amides and bis(perfluoroalkylsulphonyl)imides such as bis(trifluoromethylylsulphonyl)imide, alkyltosylates and aryltosylates, perfluoroalkyltosylates, nitrate, sulphate, hydrogensulphate, alkylsulphates and arylsulphates, polyether sulphates and sulphonates, perfluoroalkylsulphates, sulphonate, alkylsulphonates and arylsulphonates, perfluorinated alkylsulphonates and arylsulphonates, alkylcarboxylates and arylcarboxylates, perfluoroalkylcarboxylates, perchlorate, tetrachloroaluminate, saccharinate, dicyanamide, thiocyanate, isothiocyanate, tetraphenylborate, tetrakis(pentafluorophenyl)borate, tetrafluoroborate, hexafluorophosphate, polyether phosphates, dialkylphosphates and phosphates.

Very particularly preferred anions are chloride, bromide, hydrogensulphate, tetrachloroaluminate, thiocyanate, methylsulphate, ethylsulphate, methanesulphonate, formate, acetate, glycolate, lactate, dimethylphosphate, diethylphosphate, p-toluenesulphonate, tetrafluoroborate and hexafluorophosphate.

The ionic liquids or mixtures thereof used in the cleaning composition are most preferably those which contain a combination of a 1,3-dialkylimidazolium, 1,2,3-trialkylimidazolium, 1,3-dialkylimidazolinium or 1,2,3-trialkylimidazolinium cation with an anion selected from the group consisting of halides, bis(trifluoromethylylsulphonyl)imide, perfluoroalkyl tosylates, alkyl sulphates and alkylsulphonates, perfluorinated alkylsulphonates and alkyl sulphates, perfluoroalkyl carboxylates, perchlorate, dicyanamide, thiocyanate, isothiocyanate, tetraphenylborate, tetrakis(pentafluorophenyl)borate, tetrafluoroborate, hexafluorophosphate, dimethylphosphate and diethylphosphate.

The ionic liquids used in the inventive composition may also be commercially available, acyclic quaternary ammonium salts, for example quaternary fatty amine ethoxylate (TEGO® IL T16ES), cocoalkylpentaethoxymethylammonium ethosulphate (TEGO® IL K5MS), distearyldimethylammonium chloride (TEGO® IL DS) or else dimethyldi(hydroxyethyl)ammonium methylsulphonate (TEGO® IL 2MS). The ionic liquids mentioned are available from Evonik Goldschmidt GmbH.

The inventive cleaning composition preferably comprises an ionic liquid or a mixture of ionic liquids which has a melting point below 100° C., preferably below 50° C. More preferably, the ionic liquids used in the inventive composition or the mixture of ionic liquids have a melting point below room temperature.

Preferred compositions are those which comprise ionic liquids or mixtures of ionic liquids which are present in liquid form at a temperature of −50° C. to 400° C., preferably of −40° C. to 280° C. and more preferably of −30° C. to 150° C.

Particularly preferred compositions are those in which the ionic liquid or the mixture of ionic liquids has a decomposition temperature of greater than 200° C.

The inventive compositions preferably comprise ionic liquids or mixtures of ionic liquids which are soluble in water and/or organic solvents.

Very particular preference is given to using, in the inventive compositions, those ionic liquids or mixtures of ionic liquids which have both hydrophilic and hydrophobic domains as a detergent.

It may be advantageous when the ionic liquids present in the compositions are those which are biodegradable and simultaneously non-toxic. This has the advantage that residues of the cleaning composition which may be present in the cleaned substrate do not lead to any damage to the environment or humans. Such ionic liquids are used especially when the cleaning composition is used to clean articles which come into contact with the human skin, for example items of clothing.

The inventive composition may, as well as the compressed gas and one or more ionic liquids, comprise, as a detergent, further detergents which are not ionic liquids, especially those which are soluble in ionic liquids.

Such further detergents may, for example, be:
Fluorinated surfactants, as described in Eastoe, J. et al. Current Opinion in Colloid and Interface Science 8 (2003) 267-273, for example perfluoralkylpoly(ethylene oxide) copolymers.
Functionalized sulphosuccinates, for example AO-VAc (sodium bis(vinyl acetate)-8-sulphosuccinate) or AOK (sodium bis(5,5-dimethyl-4-oxohexyloxocarbonyl)sulphosuccinate) or sodium bis(PPGMBE 340)sulphosuccinate
Peracetylated gluconic acid derivatives, e.g. sodium peracetylgluconate or ammonium peracetylgluconate or sodium peracetylgluconate ethylsulphonate
Alkoxylated sulphonic esters, for example sodium PPGMBE-sulphate
Sulphated or acetylated oligo(vinyl acetate)s, as described in Fan et al. J. Am. Chem. Soc. 2005, 127, 11754-62 and Murphy et al. Colloid Surf., A 2001 180 295-299 and Tan et al. J. Am. Chem. Soc. 2005, 127, 8938.
Alkyldiethanolamines with oligovinyl acetate side chains and salts thereof, as described in Tan et al. Macromolecules 2006 39 7471-73
Multiesters as described in WO 2004/001120, for example diesters of succinic acid, of glutaric acid or of adipic acid and also esters of polyhydroxyl compounds, for example triacetin glyceryl triacetate, ethylene glycol diacetate or pentaerythrityl tetraacetate.
Polyether carbonate copolymers, as described in Tan et al. Macromolecules 2005, 124, 14818 and Sarbu et al. Nature 2000 405 165.
Peracetylated sugar compounds, as described in Raveendran et al. J. Am. Chem. Soc. 2002, 124, 7274.

Likewise useful as further detergents are organomodified siloxanes, for example: polyethersiloxanes, for example those as obtainable under the trade names TEGOPREN® or the name series TEGO® WET.

Particularly suitable polyethersiloxane derivatives are those of the following general formula (XV):

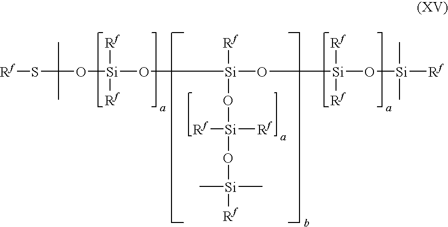

where

the R^{f} radical may be the R¹ radical, where

R¹ is an alkyl radical having 1 to 4 carbon atoms or an aryl radical, or

R^{f} is the R² or R³ radical, with the proviso that at least one R^{f} radical is the R² radical, where R² and R³ are each independently polyether radicals of the formula (XVI)

(F)_{q}(O(C₂H_{4-d}R′_{d}O)ₘ(CₓH₂ₓO)ᵣZ)_{w} (XVI)

where

d is 1 to 3

m is >1

q is 0 or 1

x is 2 to 10

r is >1

w is 1 to 4

F is a hydrocarbon radical which may also be branched,

R′ is a hydrogen radical, a monovalent hydrocarbon radical having 1 to 18 carbon atoms,

Z is a hydrogen atom or a monovalent organic radical such as alkyl, or alkyl or aryl ester, and where, in formula (XV):

b is 0 to 8,

a is 1 to 100 when b is 6 to 8,

a is 1 to 200 when b is 3 to 6,

a is 1 to 300 when b is 0 to 3.

The values of a and b should be understood as average values since the silicone polyether copolymers used in accordance with the invention are present in the form of randomly equilibrated mixtures.

The R¹ radicals are alkyl radicals having 1 to 4 carbon atoms, such as methyl, ethyl, propyl or butyl radicals, or aryl radicals, preference being given to the phenyl radicals. As a result of preparation and cost considerations, the methyl radicals are preferred, and so preferably at least 80% of the R¹ radicals are methyl radicals. Particular preference is given to those polysiloxanes in which all R¹ radicals are methyl radicals.

The siloxane mixture may be straight-chain (b=0) or branched (b>0 to 8). Experience has shown that the value of a can be combined with values of b only in the manner specified, since the increased viscosity otherwise makes handling impossible.

Particularly preferred silicone polyether copolymers are those of the general formula (XVII)

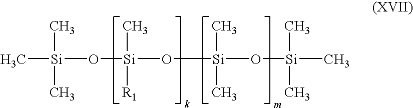

in which

m=0 to 30,

k=1 to 5,

R¹ is an allyl alcohol- or alkyl-started polyether which has been reacted with 1 to 10 ethylene oxide molecules and between 1 and 25 propylene oxide molecules.

The organomodified siloxanes used may also be functionalized polyethersiloxanes, as supplied, for example, under the product name TEGOPREN® 7100 by Evonik Goldschmidt GmbH.

The organomodified siloxanes used may also be polyether-siloxanes of blockwise structure.

Suitable polyethersiloxanes of blockwise structure are, for example, structures of the formula (XVIII)

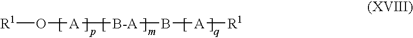

where

the A radical is a polyoxyalkylene block of average formula (XIX)

[(C₂H_{4-d}R′_{d}O)ₙ(CₓH₂ₓO)ᵣ(C₂H_{4-d}R″_{d}O)_{t]} (XIX)

where

d is 1 to 3,

n is ≧0,

x is 2 to 10,

r is ≧0,

t is ≧0,

n+r+t is ≧1, and

R′ is a monovalent aromatic, optionally substituted hydrocarbon radical,

R″ is a hydrogen radical or a monovalent hydrocarbon radical having 1 to 18 and preferably 1 to 2 carbon atoms,

R¹ is a hydrogen atom, a monovalent organic linear or branched alkyl radical of chain length C₁-C₄₀ or a carboxyl radical of a branched or unbranched alkyl or aryl ester,

B is a polysiloxane block of average formula (XX)

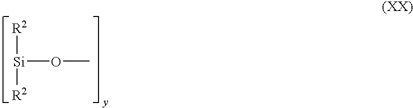

where

R² is the same or different and comprises an alkyl radical having 1 to 4 carbon atoms or a phenyl radical and

y is 5 to 200,

m is 2 to 100,

p is 0 or 1 and

q is 0 or 1, or of the formula (XXI)

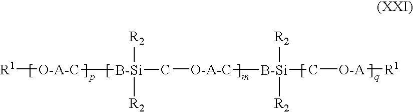

where

the R¹, A and B radicals and m, p and q are each as defined above and

C is a linear or branched alkylene radical having 2 to 20 carbon atoms.

The compounds of the structures specified are typically present in the form of random mixtures; the indices reported therefore correspond to the numerical mean values of the mixtures.

In addition, the further detergents used may be detergent formulations, as described, for example, in U.S. Pat. No. 5,858,022 (0.5% by weight of X-207 (a commercial detergent from Union Carbide—nonylphenyl ethoxylate having an HLB value (hydrophobic-lipophilic balance) of 10.5); 0.5% by weight of PDMS-g₃-PEG (polydimethylsiloxane(PDMS)-graft-polyethylene glycol(PEG) copolymer) (500 g/mol PDMS with 350 g/mol of PEG grafts, approx. 50% of PEG); 1% by weight of SpanTm 80 (a commercial sorbitan ester surfactant from ICI); 0.5% by weight of isopropanol; 0.2% by weight of water; 30% by weight of Isopar™ (a commercially available hydrocarbon solvent from EXXON; made up to 100% by weight with CO₂)).

In addition, further detergents used may be detergent formulations which are sold commercially under the brand name Fabritech®, e.g. Fabritech® 5565.

In addition, suitable further detergents are described in Eastoe et al. Langmuir 2006, 22, 9832 and in Hebach et al. Tenside Surf. Det. 42 (2005) 2 78-82.

As a result of the combination of ionic liquids as detergents with one or more of the abovementioned further detergents, the cleaning power can be improved further, especially in the case of lipophilic contaminants.

The mass ratio of ionic liquids to further detergents which are not ionic liquids is preferably from 100:1 to 1:100, preferentially 10:1 to 1:10, more preferably 5:1 to 1:5 and most preferably 2:1 to 1:2.

In addition to detergents, the inventive composition may comprise further additives which are preferably soluble in the ionic liquid(s). Such additives may, for example, be those which nourish, protect or modify the articles to be cleaned. The addition of such additives to the inventive composition allows complicated downstream treatment steps to be dispensed with. Examples are optical brighteners or bleaches, softeners, fragrances or enzymes.

The inventive cleaning compositions can be obtained by simple mixing of the components present.

The inventive cleaning compositions can be used especially in the process described below.

The process according to the invention for cleaning articles, in which the articles are contacted with a cleaning composition comprising a compressed gas and at least one detergent, is characterized in that an inventive cleaning composition is used.

The process can be carried out, for example, like conventional cleaning processes in which compressed gases are used. Such processes are described, for example, in U.S. Pat. No. 5,783,082 and the literature cited there.

The articles to be cleaned should be selected such that they are insoluble in one of the substances present in the cleaning composition.

The articles to be cleaned may, for example, be those selected from the group of textiles and yarns.

In a preferred embodiment of the process according to the invention, the article to be cleaned consists partly or completely of wool or a blend fabric which contains at least 30% by weight of wool, preferably 50% by weight of wool, more preferably >80% by weight of wool.

In a further preferred embodiment of the process according to the invention, the article to be cleaned consists partly or completely of silk or a blend fabric which contains at least 30% by weight of silk, preferably 50% by weight of silk, more preferably >80% by weight of silk.

In a further preferred embodiment of the process according to the invention, the article to be cleaned, preferably the textile or the yarn, comprises or consists of cotton or cotton blend fabric. The article to be cleaned preferably consists partly or completely of cotton or a blend fabric which comprises at least 30% by weight of cotton, preferably 50% by weight of cotton, more preferably >80% by weight of cotton. The articles to be cleaned may additionally also be those which have a surface which is wholly or partly composed of leather, which is completely or partly an animal or synthetic fur, or which is wholly or partly composed of metal, semimetal, plastic, lacquer, ceramic, wood, rubber or glass. The articles to be cleaned may preferably be items of clothing, electronic components, mechanical components, seals or packaging, especially when these articles are sensitive to water (corrosion) or air (oxidation).

The inventive cleaning composition, especially one which comprises liquid carbon dioxide as the compressed gas, can be used, for example, in a cleaning process for textiles in which liquid carbon dioxide is typically used. In such a cleaning process, the textiles to be cleaned are moved in a pressure-resistant laundry drum in the presence of the cleaning composition. The cleaning composition is preferably conducted and filtered in one cycle. At the end of the washing operation, the cleaning composition with all dissolved/dispersed substances can be discharged from the laundry drum into a second chamber. Once pressure equalization has taken place in the laundry drum, the cleaned laundry can be removed. In the second chamber the liquid CO₂ can be distilled off and transferred to a reservoir vessel. The ionic liquids can be purified by suitable process steps to remove them from the residues which cannot be distilled easily, which are formed by the impurities and at least one ionic liquid. Such process steps may, for example, be distillation steps and/or extraction steps or the like. The impurities which are removed in this way or have already been removed in the filtration can be disposed of, and the purified ionic liquids can be reused in a further process step.

The examples adduced below describe the present invention by way of example, without any intention that the invention, whose scope of application is evident from the entire description and the claims, be restricted to the embodiments specified in the examples.

Working Examples:

Test Procedure:

In a high-pressure autoclave (capacity 600 ml), wash tests were carried out on test fabric with standardized stains, obtainable from WfK Testgewebe GmbH (standard cotton based on DIN 53919, WfK code 10A, basis weight: 170 g/m², fibre count 270/270 threads/dm, weave: plain 1/1, yarn fineness: 295/295 dtex) and compressed CO₂. The autoclave contained connections to a CO₂ tank, such that filling and emptying was possible. The test fabric with standardized stains was secured in the autoclave and the appropriate additives were sprayed in via a valve. Thereafter, the autoclave was filled first with gaseous CO₂ up to a pressure of 25-30 bar, then with about 150-200 g of liquid CO₂. Subsequently, the autoclave was rotated for a certain time (wash time). After the cleaning had ended, the autoclave was kept in such a state that the cleaning liquid could flow out into a pressure vessel owing to gravity. From there, the CO₂ was decompressed. The soil and the additives remained in the pressure vessel. The entire washing operation was then repeated once more without additives (rinse time). Finally, the test fabric with standardized stains was removed and assessed visually. The results of the 5 inventive formulations (Exp. 1 to 5), of the comparative formulation (V) and of the control formulation (Co) are reproduced in Table 1.

Inspection and assessment of the cleaned substrates: The test fabric with standardized stains was assessed (visually) after cleaning according to a five-level rating scheme as compared with uncleaned comparative fabric.

1=unchanged

2=slightly improved

3=improved

4=significantly improved

5=no residues

TABLE 1

| | Wash | Rinse | | | | | | | | | | | | |
|---|---|---|---|---|---|---|---|---|---|---|---|---|---|---|
| | time | time | Pressure | Temp | | Amount | | Amount | | | | | | |
| Exp | min | min | bar | ° C. | Additive 1 | (% w/w) | Additive 2 | (% w/w) | T | R | K | S | C | Avg. |
| Co | 15 | 15 | 50 | 17 | | | | | 1 | 1 | 1 | 1 | 1 | 1.0 |
| V | 15 | 15 | 50 | 16 | WL1 | 0.2 | | | 2 | 2 | 2 | 2 | 2 | 2.0 |
| 1 | 15 | 15 | 50 | 15 | | | IL1 | 0.2 | 2 | 3 | 3 | 3 | 2 | 2.6 |
| 2 | 15 | 15 | 48 | 14 | WL1 | 0.1 | IL1 | 0.1 | 3 | 3 | 3 | 3 | 3 | 3.0 |
| 3 | 15 | 15 | 47 | 13 | WL1 | 0.1 | IL2 | 0.1 | 3 | 3 | 4 | 4 | 3 | 3.4 |
| 4 | 15 | 15 | 46 | 13 | WL2 | 0.2 | | | 2 | 2 | 2 | 2 | 2 | 2.0 |
| 5 | 15 | 15 | 45 | 12 | WL2 | 0.1 | IL2 | 0.1 | 3 | 4 | 4 | 4 | 4 | 3.8 |

Legend:
Co = control
T = tea 020 J
R = red wine 030 L
K = coffee 025 K
S = carrot juice 040 O
C = cocoa/sebum 015 F
WL1 = Fabritech 5565
WL2 = dimethyl adipate
IL1 = CAS No. 217813-30-4 (quaternary ammonium compounds, C16-18 and C18-unsaturated acryloylbis(hydroxy-ethyl)methyl, ethoxylated, C16-18 and C18-unsaturated carboxylates (esters), methylsulphates (salts), described in WO2000/068502)
IL2 = tetraalkylammonium sulphate, CAS No. 68071-95-4 (Tego ® IL T16ES, ethoxylated ethylbis(hydroxyethyl)tallow ethylsulphate from Evonik Goldschmidt GmbH

The results show clearly that the inventive formulations, as compared with industrial solutions used to date, lead to significant improvements in the case of hydrophilic stains.

The results also show that the combination of conventional detergents and ionic liquids as detergents allows a further improvement in the cleaning performance to be achieved.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. A cleaning composition comprising a compressed gas and at least one detergent, characterized in that at least one detergent is an ionic liquid.

2. The composition according to claim 1, characterized in that the detergent used is a mixture of ionic liquids.

3. The composition according to claim 1, characterized in that the compressed gas is present as a liquid or supercritical phase.

4. The composition according to claim 1, characterized in that the compressed gas is carbon dioxide, helium, argon, xenon, krypton, a nitrogen oxide, a hydrocarbon, a halogenated hydrocarbon or a halogen-sulphur compound.

5. The composition according to claim 4, characterized in that the compressed gas is carbon dioxide.

6. The composition according to claim 1, characterized in that the mass ratio of compressed gas to ionic liquids is 1 000 000:1 to 1:1.

7. The composition according to claim 1, characterized in that the ionic liquid or the mixture of ionic liquids has a melting point below 100° C.

8. The composition according to claim 1, characterized in that the ionic liquid used or the mixture of ionic liquids has a melting point below room temperature.

9. The composition according to claim 1, characterized in that the ionic liquid or the mixture of ionic liquids is present in liquid form at a temperature of −50° C. to 400° C.

10. The composition according to claim 1, characterized in that the ionic liquid or the mixture of ionic liquids has a decomposition temperature of >200° C.

11. The composition according to claim 1, characterized in that the ionic liquid or the mixture of ionic liquids is soluble in water and/or organic solvents.

12. The composition according to claim 1, characterized in that it comprises one or more further detergents which are not ionic liquids.

13. The composition according to claim 12, characterized in that the mass ratio of ionic liquids to further detergents which are not ionic liquids is from 100:1 to 1:100.

14. A process for cleaning articles, in which the articles are contacted with a cleaning composition comprising a compressed gas and at least one detergent, characterized in that a cleaning composition according to claim 1 is used.

15. The process according to claim 14, characterized in that the article to be cleaned is selected from the group of textiles and yarns.

16. The process according to claim 15, characterized in that the textiles and yarns comprise cotton or cotton blend fabric.

17. The process according to claim 14, characterized in that the article to be cleaned has a surface which is wholly or partly composed of leather.

18. The process according to claim 14, characterized in that the article to be cleaned has a surface which is wholly or partly an animal or synthetic fur.

19. The process according to claim 14, characterized in that the article to be cleaned has a surface which is wholly or partly composed of metal, semimetal, plastic, lacquer, wood, ceramic, rubber, or glass.

20. The composition according to claim 4, characterized in that the compressed gas is carbon dioxide, the mass ratio of compressed gas to ionic liquids is 1 000 000:1 to 1:1 and the ionic liquid is selected from the group consisting of C16-18 and C18-unsaturated acryloylbis(hydroxyethyl)methyl, ethoxylated, C16-18 and C18-unsaturated carboxylates (esters), methylsulphates (salts) and ethoxylated ethylbis(hydroxyethyl)tallow ethylsulphate.
